(19) United States
(12) Patent Application Publication
(10) Pub. No.: US 2018/0091315 A1
(43) Pub. Date: Mar. 29, 2018

(54) REVOCATION AND UPDATING OF COMPROMISED ROOT OF TRUST (ROT)

(71) Applicant: QUALCOMM Incorporated, San Diego, CA (US)

(72) Inventors: Ashish SINGHAL, Longmont, CO (US); David HUGHES, Raleigh, NC (US); Darren LASKO, Forest, VA (US); Jeffrey BRASEN, Boulder, CO (US); Raghavendar BHAVANSIKAR, Boulder, CO (US)

(21) Appl. No.: 15/277,501

(22) Filed: Sep. 27, 2016

(51) Int. Cl. H04L 9/32; G06F 9/44; G06F 21/57; G06F 12/02

(52) U.S. Cl. CPC H04L 9/3268; G06F 9/4401; G06F 2212/7209; G06F 12/0246; G06F 21/575

(57) ABSTRACT

Disclosed are implementation for revoking and updating a compromised root-of-trust (ROT), including a method comprising determining whether a current validation value, representative of an expected value resulting from application of a validation function to a current certificate, is to be replaced, with the current validation value being stored in a write-restricted non-volatile memory unit of the device. The method also comprises determining at boot time whether a physical presence indicator, configured to be non-actuatable from non-proximate locations, is set to a value indicating that an actuation mechanism (for actuating the physical presence indicator so as to cause content change for the write-restricted memory), has established physical presence with the device, and providing a new validation value in response to determining that the current validation value is to be replaced and that the physical presence indicator indicates that physical presence has been established.

### BACKGROUND

For products with long life span, there may be situations where a customer's root-of-trust (ROT, which includes certificate data used for signing firmware images) has been compromised and there is a need for revoking the compromised ROT and provisioning a new ROT. If the new ROT cannot be replaced, the device's chip set containing the ROT, as well the memory chip holding the validation code for the ROT, may need to be replaced, which may not be practical.

### SUMMARY

In some variations, an example method is provided that includes determining whether a current validation value, representative of an expected value resulting from application of a validation function to current certificate data used by a computing device, is to be replaced, with the current validation value being stored in a write-restricted non-volatile memory unit of the computing device. The method also includes determining at boot time whether a physical presence indicator, configured to be non-actuatable from non-proximate locations, is set to a value indicating that an actuation mechanism, configured to cause actuation of the physical presence indicator in order to cause content change for the write-restricted non-volatile memory unit, has established physical presence with the computing device, and providing a new validation value, representative of a new expected value resulting from application of the validation function to new certificate data used by the computing device, in response to determining that the current validation value is to be replaced and that the physical presence indicator is set to the value indicating that the actuation mechanism has established the physical presence with the computing device.

Embodiments of the method may include at least some of the features described in the present disclosure, including one or more of the following features.

The actuation mechanism may include one of, for example, a jumper or a dip switch.

The actuation mechanism may include a baseboard management controller (BMC) of the computing device, the BMC configured to, at least in part, actuate the physical presence indicator.

The current certificate data may include a current root certificate of a current certificate chain configured to perform signature verification.

The current validation value may include an expected hash value derived by application of a hash function to the current root certificate.

Providing the new validation value may include disabling the current validation value by setting a current status identifier associated with the current validation value to a current status value indicating that the current validation value is revoked, and activating the new validation value.

Activating the new validation value may include one of, for example, activating one of multiple pre-stored validation values provided on the write-restricted non-volatile memory unit of the computing device, or storing on the write-restricted non-volatile memory unit of the computing device the new validation value provided from a location external to the write-restricted non-volatile memory unit.

Determining whether the current validation value is to be replaced may include determining during a device reset operation whether the computing device contains a new root-of-trust content, and setting, in response to determining that the computing device contains the new root-of-trust content, a hardware indicator to a value allowing modification of the write-restricted non-volatile memory unit storing the current validation value.

Determining whether the computing device contains the new root-of-trust content may include determining by a primary boot loader (PBL) whether a secondary boot loader (SBL) contains the new root-of-trust content. Setting the hardware indicator to the value allowing modification of the write-restricted non-volatile memory unit may include setting, in response to determining that the SBL contains the new root-of-trust content, the hardware indicator to the value allowing modification of the write-restricted non-volatile memory unit storing the current validation value.

The method may further include installing on one or more memory units of the computing device, in response to a determination that the hardware indicator is set to the value allowing modification of the write-restricted non-volatile memory unit, data corresponding to the new root-of-trust content, deleting the new root-of-trust content from the SBL upon installation of the data corresponding to the new root-of-trust content, and causing a reboot of the computing device.

The computing device may include one of, for example, a mobile computing device or a stationary computing device.

The write-restricted non-volatile memory unit of the computing device storing the current validation value may include write-restricted memory implemented, at least in part, as one-time programmable read-only-memory (ROM).

In some variations, an example computing device is provided that includes memory units, including at least one write-restricted non-volatile memory unit, a physical presence indicator, and one or more processors, coupled to the memory units and the physical presence indicator. The one or more processors are configured to determine whether a current validation value, representative of an expected value resulting from application of a validation function to current certificate data used by the computing device, is to be replaced, with the current validation value being stored in the at least one write-restricted non-volatile memory unit of the computing device. The one or more processors are further configured to determine at boot time whether the physical presence indicator, configured to be non-actuatable from non-proximate locations, is set to a value indicating that an actuation mechanism, configured to cause actuation of the physical presence indicator in order to cause content change for the at least one write-restricted non-volatile memory unit, has established physical presence with the computing device, and provide a new validation value, representative of a new expected value resulting from application of the validation function to new certificate data used by the computing device, in response to determining that the current validation value is to be replaced and that the physical presence indicator is set to the value indicating that the actuation mechanism has established the physical presence with the computing device.

In some variations, an apparatus is provided that includes means for determining whether a current validation value, representative of an expected value resulting from application of a validation function to current certificate data used by a computing device, is to be replaced, with the current validation value being stored in a write-restricted non-volatile memory unit of the computing device. The apparatus further includes means for determining at boot time whether a physical presence indicator, configured to be non-actuatable from non-proximate locations, is set to a value indicating that an actuation mechanism, configured to cause actuation of the physical presence indicator in order to cause content change for the write-restricted non-volatile memory unit, has established physical presence with the computing device, and means for providing a new validation value, representative of a new expected value resulting from application of the validation function to new certificate data used by the computing device, in response to determining that the current validation value is to be replaced and that the physical presence indicator is set to the value indicating that the actuation mechanism has established the physical presence with the computing device.

In some variations, a non-transitory computer readable media is provided, that is programmed with instructions, executable on a processor, to determine whether a current validation value, representative of an expected value resulting from application of a validation function to current certificate data used by a computing device, is to be replaced, with the current validation value being stored in a write-restricted non-volatile memory unit of the computing device. The instructions are further executable to determine at boot time whether a physical presence indicator, configured to be non-actuatable from non-proximate locations, is set to a value indicating that an actuation mechanism, configured to cause actuation of the physical presence indicator in order to cause content change for the write-restricted non-volatile memory unit, has established physical presence with the computing device, and provide a new validation value, representative of a new expected value resulting from application of the validation function to new certificate data used by the computing device, in response to determining that the current validation value is to be replaced and that the physical presence indicator is set to the value indicating that the actuation mechanism has established the physical presence with the computing device.

Embodiments of the computing device, the apparatus, and the non-transitory computer readable media may include at least some of the features described in the present disclosure, including at least some of the features described above in relation to the method.

Other and further objects, features, aspects, and advantages of the present disclosure will become better understood with the following detailed description of the accompanying drawings.

### BRIEF DESCRIPTION OF THE DRAWINGS

FIG. 1 is a diagram of an example network architecture that includes computing devices configured to implement root-of-trust transfers.

FIG. 2 is a diagram of an example computing device, such as the computing devices of FIG. 1, configured to implement root-of-trust transfers.

FIG. 3A is a diagram of an example implementation of a write-restricted memory to store and control validation codes.

FIG. 3B is a diagram of a modified example implementation of the memory of FIG. 3A, which further includes an update-block register.

FIG. 4 is a flowchart of an example procedure to perform a root-of-trust transfer.

FIG. 5 is a flowchart of an example procedure to perform root-of-trust transfer, which may form at least a part of the implementation of the procedure of FIG. 4.

FIG. 6 is a flow diagram of an example procedure of a firmware update with root-of-trust transfer.

Like reference symbols in the various drawings indicate like elements, in accordance with certain example implementations.

### DETAILED DESCRIPTION

Described are implementations to replace a validation code for a replacement root-of-trust (ROT). A ROT generally refers to certificate data, which may have been provisioned to a computing system or device (e.g., a stationary computing system, such as a server, or a mobile computing device, such a processor-based smartphone), and that may be used to verify software executable on the computing device (e.g., to verify that a software image loaded during boot is an authentic image of the software supplied by the manufacturer or developer).

In some implementations, secure operation of the computing device can be provided through use of multiple boot-loaders by the computing device. For example, a primary boot loader (PBL) of the computing device is stored in an immutable on-chip read-only-memory (ROM, or some other type restricted memory with limited writability) of the computing device, and contains signature verification code to authenticate a secondary boot loader (SBL). The Primary boot loader typically does not execute from or use any external memory modules (such as double data rate synchronous dynamic random-access memory (DDR SDRAM), or other types of DRAM memory modules), but instead is configured to load the SBL into an unused portion of on-chip volatile memory (e.g., SRAM or DRAM). In some embodiments, an administrating entity (a certificate authority, the manufacturer of the computing device to which a root certificate is to be delivered, the datacenter owner for server computing systems, OEM, ODM, or some other trusted entity) generates a root certificate that contains a public key used for verifying the authenticity of other certificates, whose corresponding private key is known only to the administrating entity. The root certificate may or may not be self-signed. The root certificate is provided to a computing device (mobile or stationary) that has a public key corresponding to the secret, private key, used to verify the signed root certificate. In some embodiments, a security technique/procedure that may be used with computing devices, in order to authenticate root certificates, is to maintain a validation code/value (e.g., a hash value) of the root certificate in write-restricted non-volatile memory (also referred to as protected non-volatile storage), e.g. on-chip fuse ROM. During boot operation of the computing device (e.g., a server or a mobile device), the PBL may be configured to validate the root of certificate chain by, for example, validating the root certificate against the validation code/value (e.g., OEM_PK_HASH) stored in a non-volatile memory of the computing unit. The PBL can then validate the SBL using, for example, the public key contained in the root certificate or the public key contained in a certificate that chains back to the root certificate.

If private keys associated with the root certificate (held by the administrating entity) are compromised, revoking the validation code associated with the ROT data (e.g., the OEM_PK_HASH value stored in the computing device's non-volatile memory) may be difficult and costly. In implementations provided herein, a mechanism to revoke and provide one or more new root-of-trust validation codes is described. For example, a computing device may be provided, at the time of manufacture, with multiple validation codes (residing at a non-volatile memory), corresponding to respective root certificates (each of which may contain a different public key, and optionally self-signed by the corresponding private key, generated by the administrating entity), to allow for a previously used certificate (and its corresponding validation code) to be revoked, and for a successor key (and its validation code) to be activated. Such a mechanism of certificate data revocation and activation is referred to as root-of-trust transfer (ROT transfer). In some embodiments, the ROT transfer mechanism may be realized by providing replacement validation codes (e.g., OEM_PK_HASH) on fuse fields of the non-volatile memory of the computing device. To prevent an attacker seeking to compromise the security of the computing device, e.g., by updating PK_HASH fuse fields, the implementations described herein further include mechanisms configured to inhibit (or thwart) an attacker's ability to access and update PK_HASH fuse fields. For example, by including a physical presence indicator (e.g., actuated or implemented by a jumper of dip switch, or implemented using a baseboard management controller, or BMC) that cannot be actuated from remote locations, actuation of the physical presence indicator, and thus performance of an ROT-transfer, has to be triggered and/or controlled from a location proximate to the location of the physical presence indicator.

Thus, in some embodiments, a method is provided that includes determining whether a current validation value, representative of an expected value resulting from application of a validation function (e.g., a hash function, such as SHA-256) to current certificate data (e.g., a root certificate) used by a computing device, is to be replaced (e.g., de-activating the current validation value and using a new validation value in its place). The current validation value is stored in a non-volatile memory unit of the computing device (e.g., a hash code, maintained in an OEM_PK_HASH field of a protected non-volatile storage of the computing device). The method also includes determining at boot time whether a physical presence indicator (e.g., general purpose input output register, or GPIO, or some other hardware and/or software implementation of an indicator), configured to be non-actuatable from non-proximate locations, is set to a value indicating that physical presence has been established (i.e., that someone/something has set the actuation mechanism to the correct value to assert that physical presence has been established). The actuation mechanism may include a manual actuation mechanism, e.g., a user (with physical access to the computing device) actuating the physical presence indicator ON or OFF through a mechanical switch, or may include a remotely controllable Board Master Controller (BMC) implementation that can electrically actuate the physical presence indicator.

The method additionally includes providing a new validation value, representative of a new expected value resulting from application of the validation function to new certificate data (e.g., a replacement root certificate) used by the computing device, in response to determining that the current validation value is to be replaced and that the physical presence indicator is set to the value indicating that physical presence has been established.

As will be discussed in greater detail below, in some embodiments, determining (e.g., by a primary-boot-loader, or PBL) whether the current validation value is to be replaced may include determining during a device reset operation whether the computing device contains a new root-of-trust content, and setting, in response to determining that the computing device contains the new root-of-trust content (e.g., that the secondary-boot-loader, or SBL, contains the new root-of-trust content), a hardware indicator (e.g., a SW_ROT_STICKY_BIT indicator) to a value allowing modification of the non-volatile memory unit storing the current validation value. Providing the new validation value may include disabling the current validation value by setting a current status identifier associated with the current validation value to a current status value indicating that the current validation value is revoked, and activating the new validation value by setting a new status identifier associated with the new validation value to a new status value indicating that the new validation value is active.

In some example implementations, a total of n (e.g., with n=2, 4, 8, or any other value) OEM_PK_HASH fields in protected non-volatile storage are provided, in which case a 4-bit revocation list may be used to indicate which PK_HASH fields are revoked. In some embodiments, only OEM_PK_HASH0 may be provisioned initially, with the other three memory fields left unblown. To implement an ROT transfer, at boot, the PBL may iterate through each OEM_PK_HASH until it finds one that is not yet revoked and matches the root certificate from non-volatile storage, and uses that root certificate to authenticate the SBL that contains the new root-of-trust content. Firmware (i.e. the image containing the new root-of-trust content) can then accomplish the ROT transfer by blowing the next available OEM_PK_HASH field (e.g., first one that is all 0's) and blow the appropriate revocation fuse for the old/compromised hash. Alternatively, all four PK_HASH fields could be provisioned initially. If the current root certificate is compromised (or upon occurrence of another condition, such as passage of some pre-determined time period), the corresponding PK_HASH on the firmware is revoked. As will be discussed in greater detail below, in some embodiments, the computing device may use a “sticky” (write-once) register for blocking write access to PK_HASHn and PK_HASH_REVOC_LIST fields. When set to “1”, the hardware may block updates to those fields. Only full-chip reset (invoking PBL) may clear the SW_ROT_STICKY_BIT. This ensures that runtime firmware/software cannot perform ROT Transfer. PBL leaves SW_ROT_STICKY_BIT at “0” if SBL is a “ROT Transfer” payload (indicated by OU field in certificate chain). Post-PBL firmware can then update PK_HASHn for new root certificate(s) and the PK_HASH_REVOC_LIST, and load firmware with a new signature to non-volatile storage.

In some embodiments, PBL may be configured to check the state of a physical presence indicator, implemented as, for example, a GPIO pin or register, to allow or deny ROT transfer. When, for example, a dedicated enable bit (e.g., located in a field in the protected non-volatile storage) is set to 1 (OEM_ROT_GPIO_ENA=1), PBL checks GPIO state (input mode) at boot time. If GPIO=0, ROT-transfer is denied. If GPIO=1, ROT-transfer is allowed. The platform manufacturer may decide how GPIO is controlled: simple jumper or DIP switch for requiring physical presence, and/or control by baseboard management control (BMC) in a datacenter environment, or other methods of ensuring physical presence. In the case of a BMC, it generally is up to datacenter owner to ensure security of BMC solution for controlling GPIO.

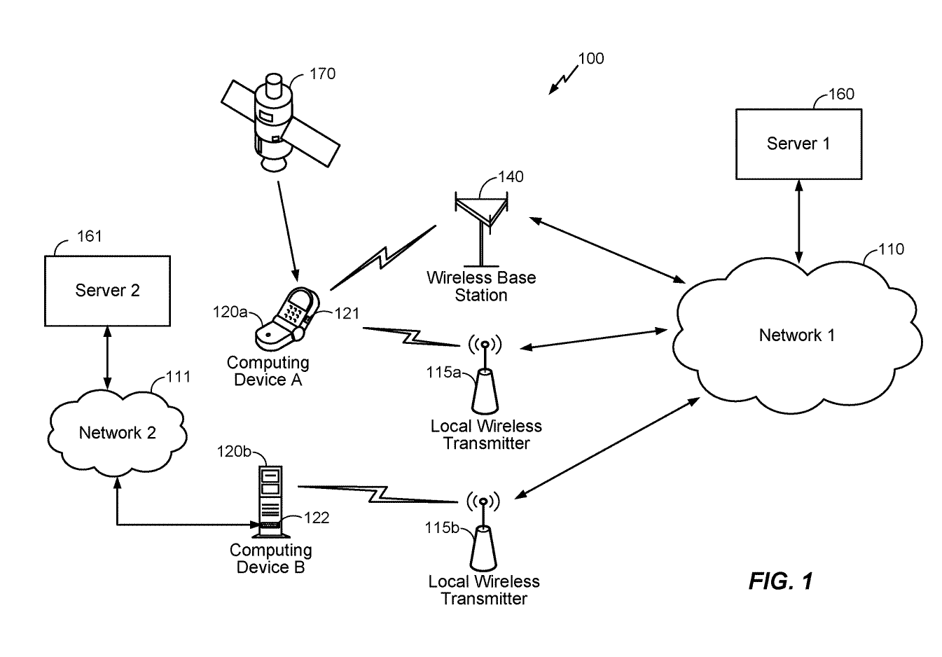

With reference to FIG. 1, a diagram of an example network environment 100, which may be suitable for implementing the techniques and procedures discussed herein, is shown. The particular configuration illustrated herein is merely an example of one network configuration in which the techniques and procedures disclosed herein may be used. Furthermore, an implementation of such a network architecture may include additional elements that are not illustrated herein and have been omitted for the sake of clarity. The example network architecture provides an example of a network environment in which computing devices 120a and 120b, each of which may be used to realize the implementations described herein, can operate. In some embodiments, the computing device can be a mobile computing device (such as the device 120a depicted in FIG. 1), or may be a device that is typically stationary (like the computing device 120b depicted in FIG. 1), such as a desktop computer system, a server (to serve multiple other computing devices, including, for example, the mobile computing device 120a), etc. The mobile computing device 120a may be a mobile communication device referred to as a User Equipment (UE), a mobile station, a terminal, an access terminal, a subscriber unit, a station, etc. The mobile computing device 120a may be a smartphone, a tablet computer, a laptop computer, game console, wearable device (such as a smart watch) or other device that includes a wireless transmitter and/or receiver that is configured to communicate using one or more wireless communications protocols, including, but not limited to, Long Term Evolution (LTE), WLAN, WiMAX wireless communications protocols, Bluetooth® wireless technology (and/or other type of near-field communication protocols), 4G networks technology, etc. The computing device 120a can also be configured to support other types of wireless or wired communications protocols and can be configured to support multiple different wireless communications protocols. The wireless transmitter of the computing device 120a can be configured to send data to and/or receive data from other devices, the wireless transmitters 115a-b, and/or one or more wireless base stations 140. In some embodiments, the computing device 120a can also be configured to measure signals from one or more wireless base stations or wireless access points, such as the wireless transmitters 115a-b and the wireless base station 140, to obtain timing and/or signal measurements that are used for positioning functionality. Although only two local terrestrial wireless transmitters are illustrated in this example, namely, 115a and 115b, more or fewer wireless transmitters may be included. The computing devices 120a and 120b can also be configured to use a combination of signals from one or more satellites, such as the satellite vehicle 170, the wireless base station 140, and/or the wireless transmitters 115a-b (those devices may also be configured to receive communications) to support and implements data communication operations, positioning functionality, and other types of operations for the computing devices 120a-b.

As noted, in some embodiments, the computing devices 120a and/or 120b may each include a physical presence indicator that is actuatable by a proximate actuation mechanism. For example, the actuation mechanism may be a mechanical switch (e.g., a DIP switch; not shown in FIG. 1) that can only be actuated (in order to change the state of physical presence indicator) from a location proximate to the physical presence indicator. As will be discussed in greater detail below, to inhibit a rogue party from compromising the ROT transfer implementations described herein, the physical presence indicator needs to be placed in a particular state (e.g., ON) before an ROT transfer process can proceed. In FIG. 1, the mobile computing device 120a is illustrated as including a mechanical switch (schematically illustrated as a block 121) to implement the actuation mechanism. Alternatively, in some embodiments, actuation of the physical presence indicator may also be achieved via a baseboard management controller (BMC) generally configured to allow remote communication functionality, remote access control functionality, etc. In such embodiments, the BMC may further be configured to allow control of the state of the physical presence indicator through remote access (e.g., an authorized entity may remotely access the BMC of the computing device(s) (e.g., via some secure access mechanism that may include use of digital certificate(s), password(s), and/or other authentication mechanisms), and only when it has gained access to the BMC can that entity cause a change of state to the physical presence indicator of the computing device. In FIG. 1, the computing device 120b is illustrated as including a BMC (schematically illustrated as a block 122) that may communicate with a remote server 161 via a network 121.

With continued reference to FIG. 1, The wireless nodes 115a-b may be connected to a network 110 (e.g., a cellular wireless network, a WiFi network, a packet-based private or public network, such as the public Internet, etc.) via a backhaul connection that provides a broadband connection to the network 110. The network 110 may be the Internet and/or a combination of one or more networks.

In some embodiments, the wireless base station 140 (which may also be referred to as an eNodeB node) can be configured to provide wireless network connectivity to a plurality of mobile devices, such as the computing devices 120a-b. The wireless base station 140 may include a macrocell base station, a femtocell base station, a picocell base station, or other type of base station. The wireless base station 140 can be configured to communicate using one or more wireless communications protocols and technologies, including protocols and technologies to implement a Code Division Multiple Access (CDMA) network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, a WiMax (IEEE 802.16), and so on. A CDMA network may implement one or more radio access technologies (RATs) such as cdma2000, Wideband-CDMA (W-CDMA), and so on. In some embodiments, 4G networks, Long Term Evolution (“LTE”) networks, Advanced LTE networks, Ultra Mobile Broadband (UMB) networks, and all other types of cellular communications networks may also be implemented and used with the systems, methods, and other implementations described herein. While the example illustrated in FIG. 1 includes a single wireless base station, in other implementations the network environment may include more than the wireless base station 140.

As further shown in FIG. 1, the network environment 100 may further include a server 160 (e.g., an administrator server, a location server, such as an Evolved Serving Mobile Location Center (E-SMLC) server, or any other type of server) configured to communicate, via the network, or via wireless transceivers included with the server 160, with multiple network elements or nodes, and/or mobile wireless devices. The server 160 may be configured to establish communication links with any of the nodes and/or computing devices illustrated in FIG. 1 either directly, or indirectly through intermediary node (e.g., establish wired or wireless communication links with the computing devices 120a-b directly, or via one of the nodes 115a, 115b, and/or 140). The server 160 may correspond to a server of a trusted entity (such as an administrator, a certificate authority, the manufacturer(s) of the computing devices 120a-b, etc.) to provide digital certificate data (e.g., root certificate data and/or other components of certificate chains) and to implement ROT-transfer procedures. In embodiments in which the computing device includes a BMC (e.g., connected to the stationary computing device 120b), communication to and from the BMC 121 may be achieved through a network communication link (via a network 111, which may be a private or public network) to a server 161 configured, for example, to allow remote control and management of the BMC.

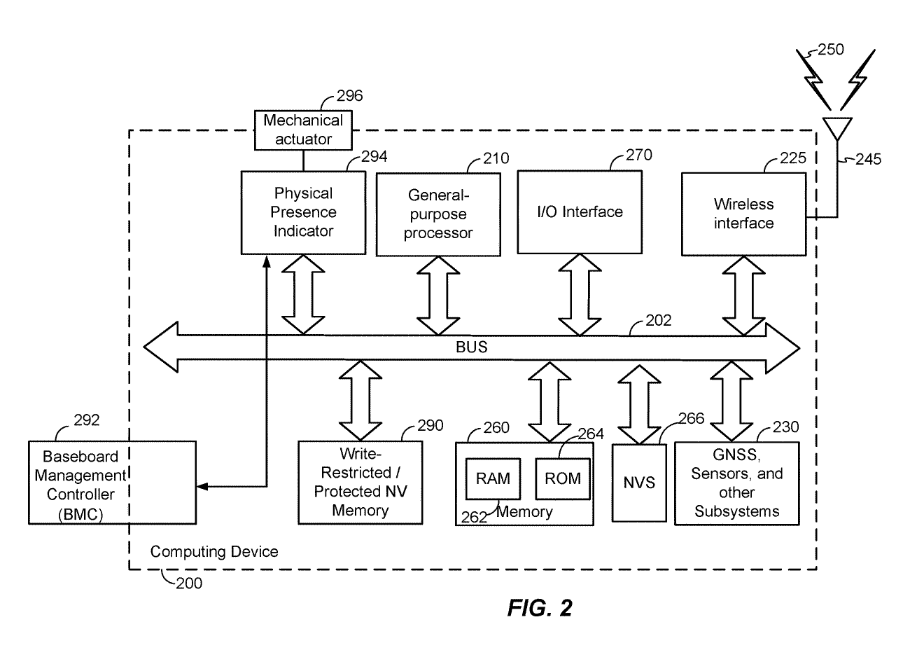

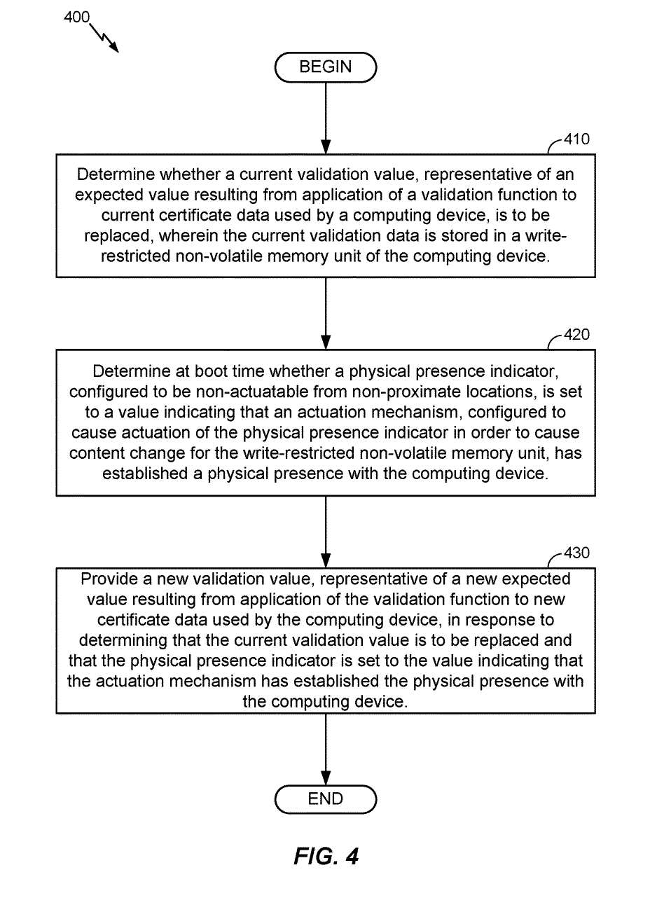

With reference now to FIG. 2, a block diagram of an example computing device 200 that can be used to implement either one of the computing devices 120a and/or 120b depicted in FIG. 1, is shown. The computing device 200 may be used to implement, at least in part, any of the processes described herein, including the processes illustrated in FIGS. 4-6. The computing device 200 may comprises various types of computing devices, including but not limited to, laptop or other personal computer systems, tablet computers, mobile phones, smartphones, game consoles, wearable devices (e.g., a smartwatch, head-mounted device, etc.), servers, and/or other types of computing devices.

The computing device 200 includes at least one processor 210, a non-transitory memory 260, connected to each other by a bus 202, and a non-volatile storage 266. In some embodiments, e.g., embodiments in which the computing device is implemented as a wireless mobile device, the device 200 may also include a wireless interface 225 (which may include a wireless receiver, transmitter, transceiver, and/or other elements that allow the computing device 200 to send and/or receive data using WWAN, WLAN, and/or other wireless communication protocols). Also schematically illustrated in FIG. 2 is a module 230 comprising other subsystems that may be (but do not have to) included with the computing device 200. Such other subsystems may include, for example, a GNSS interface (which may be connected to an antenna for receiving signals from, for example, satellite systems that as the satellite 170 illustrated in FIG. 1), and/or one or more sensors, including, for example, motion or inertial sensors (such as an accelerometer, a gyroscope, a geomagnetic (magnetometer) sensor, any of which may be implemented based on micro-electro-mechanical-system (MEMS), or based on some other technology), an altimeter (e.g., a barometric pressure altimeter), a thermometer (e.g., a thermistor), an audio sensor (e.g., a microphone), an optical sensor such as a camera (e.g., a charge-couple device (CCD)-type camera, a CMOS-based image sensor, etc.), and/or other sensor types. The at least one processor 210 may be a general-purpose processor. Other implementations of the computing device 200 may include additional elements not illustrated in the example implementation of FIG. 2 and/or may not include all of the elements illustrated in the example embodiment illustrated in FIG. 2. The computing device 200 can include a wired network interface instead of or in addition to the wireless interface 225.

I/O interface 270 can provide one or more ports and/or other interfaces that can provide for data inputs and/or outputs to the computing device 200. For example, the I/O interface 270 can include one or more ports, such as a Universal Serial Bus (USB) port and/or other type of port that can be used to connect external devices to the computing device 200. The I/O interface 270 can also include one or more input devices, such as buttons, switches, a keypad, a touchscreen and/or other means for receiving input from a user. The I/O interface 270 can also include one or more means, modules, mechanisms, and implementations, to output audio and/or visual content, such as a screen, a speaker, a headphone port and/or other means for outputting such content.

The processor 210 may be an intelligent device, e.g., a personal computer central processing unit (CPU), a microcontroller, an application specific integrated circuit (ASIC), etc. The memory 260 may be a non-transitory storage device that can include random access memory (RAM) 262, and read-only memory (ROM) 264, or a combination thereof. The ROM 264 contains, among other code segments/programs, the code for the PBL which is configured to handle, at least in part, the ROT-transfer process. The non-volatile storage 266 (e.g., realized, for example, as SPI-NOR flash memory) contains the code for various software applications executable on the processor 210 of the computing device 200, as well as control and security-related code segments. For example, the non-volatile storage 266 may include the root certificate used by the computing device. The memory 260 can store processor-readable, processor-executable software code containing instructions for controlling the processor 210 to perform functions described herein (although the description may read that the software performs the function(s)). The software can be loaded onto the memory 260 by being downloaded via a network connection, uploaded from a disk, a flash drive, a DVD (or any other medium), etc. Further, the software may not be directly executable, e.g., requiring compiling before execution.

The software in the memory 260 is configured to cause the processor 210 to perform various actions, including implementing sending and/or receiving data from the wireless nodes 115a-b, the wireless base station 140, other mobile devices, and/or other devices configured for wireless communication. The software in the memory 260 can also be configured to cause the processor 210 to perform all or part of one or more of the processes described herein, including the ROT-transfer processes. The processes described herein can also be implemented in hardware components of the computing device 200 or can be implemented as a combination of hardware and software components.

In the example embodiments of FIG. 2, the computing device 200 further includes a restricted programmable memory 290 which may be a one-time programmable non-volatile memory (e.g., programmable ROM comprising one-time writable memory elements that may be referred to as on-chip fuses). In some embodiment, the write restricted memory 290 includes memory areas with content that may have been added (programmed) at the time of manufacture of the computing device 200. The restricted memory 290 may contain one or more validation codes or values representative of expected values from application of a validation function (e.g., a hash function, such as SHA-256, or any other type of a hash function, or some other data-mapping function) to certificate data that is used for security and authentication processes of the computing device 200. For example, to implement a secure multi-stage boot process, the validation function is applied to a root certificate provided to the computing device, and the resultant value is compared to the currently active validation code (e.g., OEM_PK_HASH, which may be a hash value resulting from applying a hash function to a root certificate provided by the manufacturer) to determine if the computed value matched the pre-determined expected value that was placed in the write-restricted memory 290, for example, at the time of manufacture of the computing device 200.

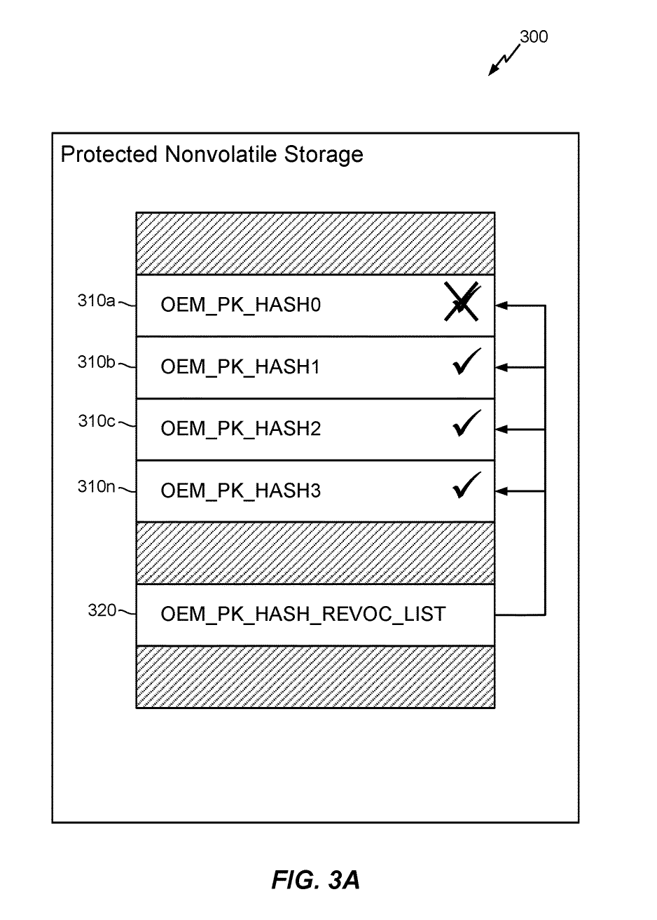

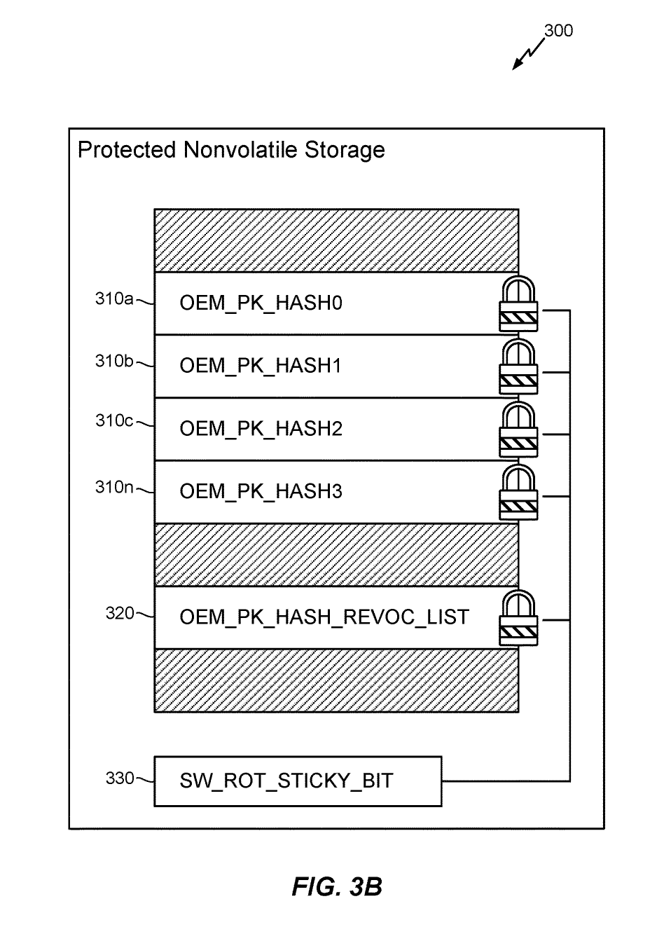

FIG. 3A is a diagram of an example implementation of a write-restricted memory 300 (which may be similar in its implementation and functionality to the memory 290 of FIG. 2) to store and control revocable validation codes. The write-restricted memory 300 is marked, in FIG. 3A, as a security control memory area. The write-restricted memory 300 (which is configured to restrict the extent to which content written to that memory area can be modified) includes multiple validation codes written into corresponding multiple memory elements 310a-n of the memory 300. Once content is recorded into the memory element 310a-n, they are generally non-modifiable, and thus, once the validation code data is placed into them (e.g., at the time of manufacture), that content cannot be modified. In some embodiments, one or more of the memory elements 310a-n may be provided without content (i.e., blank) to allow content to be placed on those blank elements at some later point (post-manufacture, e.g. when the private key associated with the current validation code has been compromised, and a new validation code corresponding to a new root certificate is to be provisioned).

As further illustrated in FIG. 3A, the restricted memory may include a revocation list 320 with one-time modifiable memory elements (e.g., on-chip fuses that are initially provided blank, i.e., without any content initially written to them). Content written to the revocation list 320 may be used to identify or represent any validation code that may have been retired or revoked. For example, as noted, the revocation list may include multiple 1-bit on-chip fuses that are each associated with a respective one of the memory elements 310a-n configured to store validation codes. When a validation code (e.g., containing an expected value of a validation function applied to an associated root certificate) is revoked, the corresponding memory element (e.g., on-chip fuse) on the revocation list may be set (or blown) to indicate that that validation code is no longer in use. In some embodiments, during the boot process, the primary boot loader (PBL) may initially iterate through each of the validation codes in the memory elements 310a-n until it identifies a memory element whose corresponding revocation list memory element has not been set to a value indicating revocation. That first identified memory element will contain the validation code that is presumed to be currently active, and accordingly the boot process will use that value to authenticate the root certificate and to proceed with the boot process (e.g., to load the secondary boot loader, and complete the boot process). Thus, when the content stored at the memory element 310a is to be revoked (e.g., due to passage of time, or because of suspected compromise of the private key associated with one of the currently provisioned root certificates), the corresponding memory element (e.g., bit) of the revocation list 320 will be set to a value representative that the validation code held in the memory element 310a is no longer valid or active. At the next boot cycle, the computing device will initially access the revocation list 320 of the protected nonvolatile (also referred to as write-restricted) memory 300 (e.g., during the primary boot loader operation) and scan/traverse the revocation list to identify the first memory cell not marked as revoked. The validation code in the memory element corresponding to that memory bit will be used as the active validation code against which the value derived from application of a validation function to the current root certificate will be compared (in the example of FIG. 3A, the first non-revoked validation code is shown as memory element 310b, corresponding to OEM_PK_HASH1, which may be the hash value resulting from applying the designated hash function to a first root certificate provided by the manufacturer). As noted, in some embodiments, at least some of the memory elements 310a-n are not written to during manufacture, and thus the computing device may, when performing an ROT transfer to revoke the current validation code and provide a new validation code, use the next unused memory element from 310a-n (e.g., blowing the on-chip fuses to record the new expected validation code corresponding to the new root certificate to be used). Alternatively, in some embodiments, the PBL triggers a search to find the first non-revoked OEM_PK_HASHn. However, if the OEM_PK_HASHn does not match the hash of the root certificate, PBL iterates to the next OEM_PK_HASHn value from the fuse ROM. The process continues until PBL either finds a match (in which case secure boot continues) or until all OEM_PK_HASHn values have been tried without a match (in which case secure boot halts).

In some embodiments, to ensure that updates of the memory elements (e.g., the elements 310a-n, and the revocation list 320) cannot be performed during runtime, and that ROT transfers (which include updating of one of the plurality of the memory elements 310a-n, as well as the updating of the revocation list 320) are performed only during the booting cycle of the computing device, an update-block register may be used to inhibit updating operations of the write restricted memory during runtime. Thus, with reference to FIG. 3B, a modified schematic diagram of the write-restricted memory 300 of FIG. 3A is shown, which includes a “sticky” (update-block) register 330 (marked in FIG. 3B as “SW_ROT_STICKY_BIT”). When set to a value (e.g., ‘1’, ON, or some other pre-determined value) indicating that updates to the write-restricted memory 300 (and thus to the elements 310a-n and the revocation list 320) are blocked (or that the memory elements 310a-n and the revocation list 320 are locked), the computing device (e.g., the device 200 of FIG. 2) is prevented/inhibited from performing updates to the restricted memory 300.

In some of the implementations described herein, upon a full-chip reset (in which PBL is invoked), the register 330 may be cleared, to thus allow updates to the memory 300 if such updates are required. Ordinarily, when there is no need to perform an ROT transfer, the PBL may, when being executed, set the update-block register 330 to a value blocking/inhibiting updates to the memory elements 310a-n and/or the revocation list 320, thus preventing an ROT transfer from being performed (and, as a result, inhibiting a rogue user/attacker from directly modifying the security-critical on-chip protected non-volatile storage after the PBL runs). However, if it is determined that the currently active validation code in memory elements 310a-n is to be replaced, e.g., because it is determined that there is a new ROT transfer payload (as may be indicated by an Organization Unit, or OU, field in the certificate chain), the PBL is configured to leave the update-block register at a value (e.g., ‘0’) allowing updates to the restricted memory 300, and thus allowing an ROT transfer to be performed. Post-PBL firmware can then update one of the memory elements 310a-n and/or the revocation list 320 (e.g., provide a new PK_HASH value to be recorded in the next unused memory element in situations where the validation codes are not all provided at the time of manufacture, and/or set the appropriate memory storage on the revocation list 320 to a value indicating revocation of the current validation code that results in the next validation code being activated), and load firmware with a new signature(s) to, for example, non-volatile storage. In some embodiments, once the restricted memory 300 has been update with the data corresponding to the new ROT transfer (e.g., a new validation code provided, or one of the existing, previously provided, validation codes is activated) the post-PBL process(es) are configured to set the update-block register 330 to a value inhibiting further updates.

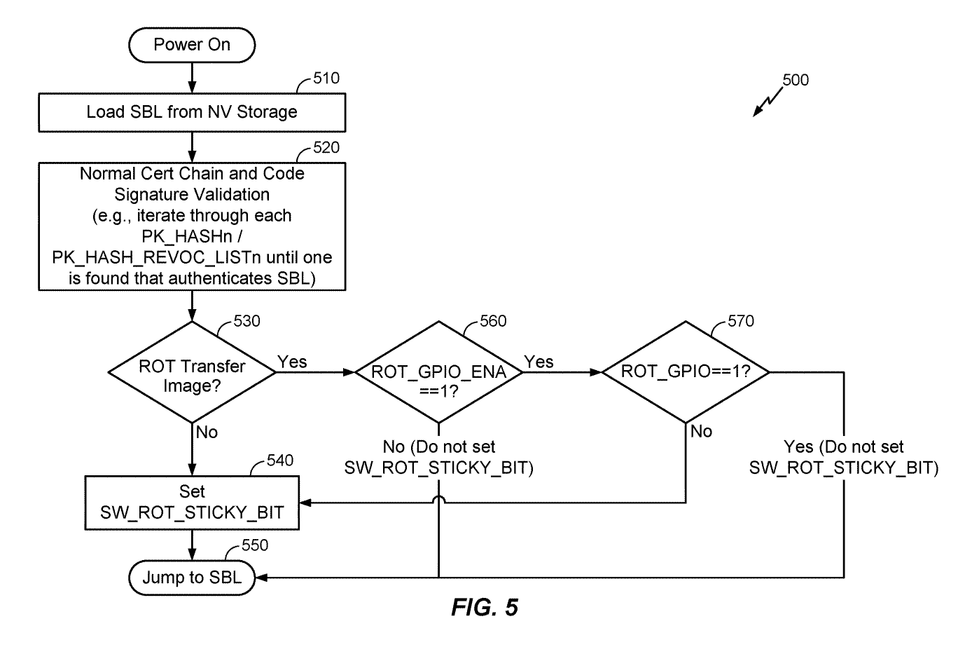

As noted, providing a new validation value (e.g., a new OEM_PK_HASH value in the examples of FIGS. 3A and 3B), either by recording it in an available, unused, memory element from the write-restricted memory 300, or by identifying a non-revoked previously recorded validation code stored at one of the memory elements 310a-n, is performed in response to determining that the current validation code is to be replaced and that a physical presence indicator is set to a value indicating that physical presence has been established for an actuation mechanism configured to cause physical actuation of the physical presence indicator. Thus, and referring back to FIG. 2, the computing device 200 further includes, in some implementations, a physical presence indicator 294, and may correspond to a general-purpose input/output (GPIO) pin of an integrated circuit (which may correspond to the flag ROT_GPIO illustrated in FIG. 5), or may otherwise be implemented as a memory element, a hardware-based implementation (e.g., a switch-based circuit), or a hardware and software based implementation, etc., and may be configured to control and indicate a state (e.g., ON or OFF). A state value of ON, or ‘1’, may represent that physical presence has been established with the computing device 200, and that, therefore, a party, entity, or mechanism, requesting or authorizing an ROT transfer (to cause the revocation of a current validation code and the provisioning of a new validation code) is situated near-by to the computing device 200. A state of ON, or ‘1’, for the physical presence indicator may thus indicate that ROT transfer operations are allowed. The use of the physical presence indicator 294 can inhibit a rogue party from remotely attempting to compromise the computing device's security because the physical presence indicator provides a measure of assurance that the request for the ROT transfer is provided from a locally present mechanism (i.e., the requesting party, entity, or actuation mechanism, needs to be locally present).

In some embodiments, the actuation mechanism may be implemented via a mechanical actuator 296, such as a DIP switch or a jumper. When a mechanical actuator is used, in order to initiate an ROT transfer a person/operator would need to physically actuate the mechanical actuator 296 (and therefore would have to be physically present near the computing device 200), which in turn cause a change of the state of the physical presence indicator 294. Alternatively and/or additionally, in some embodiments, the actuation mechanism may include a baseboard management controller (BMC) 292 that is coupled to the computing. A BMC is a service processor configured to monitor the physical state of a computer, server or other hardware device, and is typically housed on the motherboard of the computing device it is configured to monitor (in some embodiments, the BMC 292 may be housed within the housing of the computing device 200, or may be implemented as an independent module, with its own housing, that is connectable to the computing device 200). The BMC is configured to communicate with a system administrator, or some other authorized party, through an independent connection (e.g., to communicate via a network, such as the network 111 of FIG. 1. with a server, such as the server 161, using a dedicated or shared communication module that may separate from the communication module(s) of the computing device). Such an independent connection may include a mechanism to authenticate and verify the identity and privileges of the party gaining access to the BMC. A BMC may also be configured to provide functionality such as remote power control, remote access to access server status and diagnostics, remote access system alerts, and remote console functionality. In some embodiments, the BMC may include sensors to measure and determine such data as power-supply voltage, temperature, communication channel characteristics, and other functionality attributes of the computing device being monitored (e.g., the computing device 200 in the example of FIG. 2). The BMC may be configured to automatically take corrective action to mitigate problems identified from the data collected by it, or alert the administrator (or other authorized party) about detected issues, to thus prompt the administrator to take remedial action. The BMC may also be configured to use digital certificate(s), password(s), and/or other authentication mechanisms. In some embodiments, to allow the ROT transfer in a computing device (generally a stationary computing device) comprising a BMC, an authorized user (such as the computing device's administrator) accesses the BMC (following the authentication/verification procedure implemented for the BMC 292). Once the authorized party has gained access to the BMC, the authorized party may provide an actuation signal (e.g., a command, communicated remotely to the BMC 292 of the computing device 200), in response to which, the BMC causes the physical presence indicator 294 to be changed to a state (e.g., ON state, Active state, etc.) required to allow an ROT process to be performed (e.g., when it is determined that the current validation value, stored on the write-restricted memory 290, is to be replaced).

With reference now to FIG. 4, a flowchart of an example procedure 400 to perform a root-of-trust transfer (e.g., updating of validation code when the current certificate chain for a computing device, such as the computing devices 120a-b or 200 of FIGS. 1 and 2, needs to be revoked and replaced with a new certificate chain) is shown. The procedure 400 includes determining 410 whether a current validation value (e.g., such as the OEM_PK_HASH values), representative of an expected value resulting from application of a validation function to current certificate data (which may include the current root certificate) used by a computing device (such as the computing device 200 of FIG. 2), is to be replaced, with the current validation value being stored in a write-restricted non-volatile memory unit (such as write-restricted memory 300 depicted in FIGS. 3A and 3B) of the computing device. As noted, the validation function may be, for example, a hash function (e.g., SHA-256), that is applied to the root certificate stored on the computing device (e.g., in non-volatile memory, such as the non-volatile storage 266 of FIG. 2) to produce a resultant hash value. That hash value is then compared to the expected current validation code (OEM_PK_HASH) stored in the write-restricted memory (e.g., the memory 290 or 300, respectively depicted in FIGS. 2 and 3A-B). If there is a discrepancy between the resultant validation value derived through application of the validation function on the current root certificate, and the expected value, this may indicate that security of the computing device has been compromised.

In some embodiments, when a root-of-trust is to be replaced, the computing device receives a new root-of-trust content (e.g., root-of-trust image data) that may be stored with the secondary boot loader (SBL) unit implementation (realized via hardware, software, and/or firmware) of the computing device. In some embodiments, the receipt of a new root-of-trust payload may be indicated through an Organizational Unit (OU) field in the certificate chain. The OU field can thus server as a flag or indicator to indicate the presence of a special FW image (for the ROT-transfer) that get authenticated through the standard certificate chain signature verification process. Other ways to indicate the presence/existence of the special image/payload may also be used. The receipt of a new root-of-trust payload may trigger a full-chip reset of the computing device, or, alternatively, the reset may be delayed until current operations performed by the computing device have been completed. In some embodiments, determining that the current validation value is to be replaced (i.e., that a ROT transfer is to be performed) may be based on receipt of some indication or a flag requesting that the current validation code be revoked. Such a request may occur in response to a determination of the existence of a risk of a security breach, or may occur periodically (e.g., every ½ year, or some other period) in order to preemptively vary the security mechanisms used by the computing device. In some embodiments, the platform owner could set the policy as to when to update the ROT.

With continued reference to FIG. 4, the procedure 400 further includes determining 420 at boot time (e.g., during performance of the PBL processes) whether a physical presence indicator (such as the register 294 of FIG. 2, e.g., a GPIO pin), configured to be non-actuatable from non-proximate locations, is set to a value indicating that an actuation mechanism (configured to cause actuation of the physical presence indicator in order to cause content change for the write-restricted non-volatile memory unit) has established a physical presence with the computing device (e.g., that the actuation mechanism has set the indicator, from a location proximate to the indicator, to the appropriate value). As discussed herein, actuation of the physical presence indicator may be performed by a baseboard management controller (BMC) (in implementations in which the computing device includes a BMC). In such embodiments, an authorized party would first securely access the BMC of the computing device (the authorized party would need to be authenticated), and could then cause the BMC to actuate the physical presence indicator, when the current validation code is to be replaced, to a state allowing the validation code replacement procedure (and thus the ROT transfer procedure) to take place. Actuation of the physical presence indicator by the BMC may be performed in response to a signal or command sent remotely from the authorized party that has gained remote access to the computing device via the BMC. As also noted, in some embodiments, actuation of the physical presence indicator may be performed using a physical/mechanical actuator, such as a jumper or DIP switch positioned on the housing of the computing device (e.g., the housing of a mobile device or server). Thus, in such situations, to replace the validation code, a user (e.g. the owner of the device, or some other authorized user) would need to physically actuate the mechanical actuator in order to set the physical presence indicator to the state required to perform the ROT transfer. Actuation of the mechanical actuator may toggle the value of the physical presence indicator to change its current state to another of the indicator's possible states, and thus, in such situations, the mechanical switch would not necessarily need to be mechanically reset to some initial position. Alternatively, in some embodiments, upon completion of an ROT transfer procedure (including replacement of a validation code), the mechanical actuator may automatically be reset to its initial position.

As further illustrated in FIG. 4, the procedure 400 includes providing 430 a new validation value, representative of a new expected value resulting from application of the validation function to new certificate data used by the computing device, in response to determining that the current validation value is to be replaced and that the physical presence indicator is set to the value indicating that the actuation mechanism has established the physical presence with the computing device. Providing the new validation value (e.g., an expected hash code that is to be compared to resultant hash code derived from application of a hash function to the currently active root certificate) may include disabling the current validation value by setting a current status identifier (e.g., one of the memory bits/units constituting the revocation list 320 in the example of FIGS. 3A-B) associated with the current validation value to a current status value indicating that the current validation code is being revoked, and activating the new validation value. As noted, activating the new validation value may include activating one of multiple pre-stored validation values provided on the write-restricted non-volatile memory unit of the computing device. For example, the computing device may have been provided, at the time of manufacture, with multiple validation codes. A revocation list can be used to determine and control which of those validation codes is the currently active one (or alternatively, which of the validation codes have not yet been revoked), and which of the revocation codes have already been revoked. For example, when a validation code is revoked, a corresponding memory unit (e.g., a bit) is written with a value indicating that the corresponding validation code has been revoked (because the revocation list is stored in a write-restricted memory, the content of the written memory unit cannot subsequently be modified). During boot processing, the PBL (or some other module of the computing device) may scan the revocation list to identify the first non-revoked validation code, and use that value as the expected validation code to compare against a resultant validation code computed based on the current certificate data used by the computing device (e.g., the current root certificate). In some embodiments, the computing device may have been provided with only a single current validation code, but may include non-used (blank) memory elements into which new, replacement, validation codes may be written (in some implementations, the write-restricted memory may be provided with additional three (3) blank memory elements). Thus, in such embodiments, when the current validation code (as well as the certificate chain) needs to be replaced, the expected validation code may be provided from an external, remote, location (e.g., communicated from a remote server, and received, for example, by the BMC in embodiments where the computing device includes a BMC). Adding the replacement validation code to the write-restricted memory may be performed after setting the physical presence indicator to a state allowing those operations to be performed, with the physical presence indicator actuated to the appropriate state using a mechanical actuation mechanism and/or an electrical actuation mechanism (e.g., implemented using a BMC). As noted, in some embodiments, the computing device may have been provisioned with multiple validation codes, and the PBL then iterates (during boot) through each until it finds one that is: (a) not revoked, and (b) matches the value calculated by hashing the root certificate from the non-volatile storage device.

During an ROT transfer procedure, the computing device may be configured to replace the new certificate data (e.g., new certificates, which include a new set of public keys) in response to a determination that, for example, the SBL contains a new ROT transfer content (ROT transfer image). In such situations, the procedure 400 may further include setting a hardware indicator (such as the update-block 330 depicted in FIG. 3B) to a value allowing modification of the write-restricted non-volatile memory holding the validation codes (e.g., the write-restricted memory 290 or 300 of FIGS. 2 and 3A-B). As noted, in some example embodiments, that hardware indicator (e.g., the update-block register) may be set to a value of ‘0’ in order to allow content to be written into that write-restricted memory. With the hardware indicator set to the proper value allowing modification of the memory holding the validation codes, the SBL, for example, may install, on one or more memory units of the computing device (such as the non-volatile storage 266 depicted in FIG. 2), the new firmware signed with a new set of keys. Upon installation of the new firmware on the computing device's memory (e.g., to the non-volatile storage 266), the new root-of-trust image content is deleted, and a reboot of the computing device is triggered to boot with the new firmware that is authenticated with the new certificate chain.

With reference now to FIG. 5, a flowchart of an example embodiment of a procedure 500 to perform root-of-trust transfer (the procedure 500 may form at least a part of the implementation of the procedure 400 of FIG. 4) is shown. As illustrated, upon powering of a computing device (such as the computing device 120a-b or 200 of FIGS. 1 and 2, respectively), the PBL loads 510 the secondary-boot-loader (SBL) from the computing device's non-volatile memory (e.g., the non-volatile storage 266 of FIG. 2, which may include flash memory, or other types of non-volatile memory), and normal certificate chain and code signature validation operation are performed 520. For example, during the operations of 520, the computing device may search through the validation codes and the revocation list stored on the write-restricted memory of the computing device to identify a validation code (e.g., a hash code) that authenticates the SBL (e.g., matches a value resulting from application of a validation function, such as the hash function used by the PBL, on the root certificate of the certificate chain included with the SBL). The PBL then determines 530 if the non-volatile memory include a new ROT transfer image, which may have been previously written to the non-volatile memory via, for example, a standard unified extensible firmware interface (UEFI) firmware update capsule procedure.

If there is no new ROT-transfer content/image, the procedure 500 sets 540 the update-block register (e.g., SW_ROT-STICKY_BIT of the example of FIGS. 3A-B) to a value (e.g., ‘1’) indicative that modification of the write-restrict memory of the computing device (where the validation code and the revocation list to control the validation codes are stored) is not allowed, thus preventing or inhibiting an attacker from modifying content stored on the write-restrict memory. As noted, during device reset, the value of the update-block register may be reset to a value (e.g., ‘0’) allowing modification of the write-restrict memory. Operation of the computing device then proceeds with SBL operations (at 550).

If, on the other hand, there is a new ROT-transfer image (including, for example, new certificate data), in some embodiments, a further determination is made, at 560, of whether the computing device is configured to require use of a physical presence indicator as part of the ROT transfer procedure. For example, a value, such as an ROT_GPIO_ENA fuse or register (stored in the write-restricted memory 290), is checked to determine if it is set to a value (e.g., ‘1’) indicating that a physical presence indicator mechanism is to be checked/used as part of the ROT transfer process. If it is determined (at 560) that the physical presence indicator mechanism is not to be used (e.g., ROT_GPIO_ENA is set to a value different than ‘1’, such as ‘0’), no change is made to the update-block register (e.g., its value remains ‘0’), and operation of the computing device then proceeds with SBL operations (at 550), i.e., in this situation, the ROT-transfer is performed without checking for the state of the physical present indicator.

When it is determined (at 560) that the physical presence indicator mechanism is to be used (e.g., ROT_GPIO_ENA register is set to ‘1’), another determination is made, at 570, of whether a near-by actuation mechanism actuated the physical presence indicator (e.g., ROT_GPIO, or simply GPIO, pin) to a value indicating that modification of the write-restricted memory is allowed (and, thus, that the ROT transfer is allowed). As noted, the computing device may be configured to allow actuation of the physical presence indicator only through near-by actuation mechanisms, such as through a mechanical actuator (a DIP switch or jumper to cause the GPIO pin to be set to the appropriate value) and/or a BMC that can cause the physical presence indicator (e.g., the GPIO pin) to be set to the appropriate value when an authorized user sends a remote command or signal, via the BMC, to do so. If the physical presence indicator is set to a value allowing modification of the write-restricted memory (and thus allowing the ROT transfer), no change is made to the update-block register (e.g., it remains at a value of ‘0’), and the operation proceed to SBL operations (at 550), whereupon modification of the content of the write-restricted memory can be performed. Particularly, the SBL, which contains a new ROT transfer image, updates the PK_HASHn memory elements and the revocation list (which it is allowed to do, having determined that the physical presence indicator was actuated to a value allowing modification of the write-restricted memory), and installs new firmware (signed with new keys). Subsequently, the ROT transfer image is deleted, and the computing device is rebooted.

If, on the other hand, the physical presence indicator is set to a value (e.g., ‘0’) indicating that it was not actuated (e.g., because no near-by actuation mechanism caused its actuation to a value allowing modification of the write-restricted memory), the update-block register (e.g., SW_ROT_STICKY_BIT) is set to a value (e.g., ‘1’) preventing modification of the write-restricted memory, and, in effect, denying the ROT transfer.

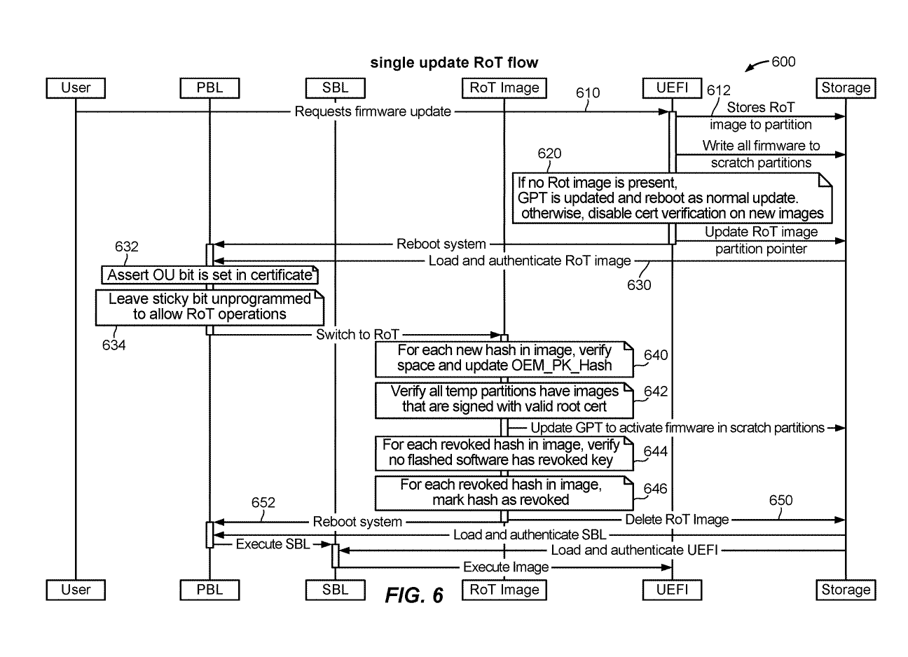

FIG. 6 is a flow diagram of an example procedure 600 of a firmware update with ROT transfer, showing various operations performed to deliver the ROT transfer payload and update the firmware on a computing device (such as the computing devices 120a-b and 200 of FIGS. 1 and 2). The example process 600 is shown without use of a physical presence indicator. However, some embodiments of the process 600 may include additional functionality corresponding to use of the physical presence indicator as described herein. Thus, a request for firmware update, along with a new ROT image (or payload), is delivered (at 610) to the computing device via a UEFI interface, and placed (at 612) into the computing device's non-volatile storage (e.g., the storage 266 of FIG. 2). The UEFI can check whether a new ROT image is present (at 620), and if so (i.e., when the request sent at 610 included a new ROT image/payload), certificate verification for the new images is disabled (because the previously stored certificates are no longer valid). Subsequently, upon the next system reboot, the PBL loads and authenticates ROT image (at 630), determines (at 632) whether the OU field in the payload is set to a value indicating a ROT transfer (i.e., that the payload corresponds to a new ROT image). In implementations in which a physical presence indicator is used, a determination may be made, once it is determined whether a new ROT-transfer image is available, has been set to indicate that an actuation mechanism (e.g., a mechanical actuator or a BMC) has established physical presence with the computing device.

Next, at 634, the update-block register (the SW_ROT_STICKY_BIT, in some of the implementations described herein) is set to a value allowing firmware updates (e.g., if the sticky-bit is already set to ‘0’, the computing device leaves the bit unchanged). Firmware updates, and other ROT transfer operation can now proceed. Thus, the validation codes (OEM_PK_HASH) are updated (at 640, e.g., in the manner described herein in relation to FIGS. 3A, 3B, 4, and 5), and a verification is performed that temporary partitions have images that are signed with the valid root certificate (at 642), and that none of the software in non-volatile memory is using a certificate chain that does not have a valid validation code in the write-restricted nonvolatile memory (at 644). Additionally, as discussed, a validation code that is to be revoked is marked as revoked (at 646, using, for example, an implementation such as the revocation list 320 depicted in FIGS. 3A and 3B). Subsequently, the ROT image is deleted (at 650) and the system is rebooted (at 652) through the multi-level boot loader (e.g., PBL and SBL) and using the updated firmware.

The methodologies described herein may be implemented by various means depending upon the application. For example, these methodologies may be implemented in hardware, firmware, software, or any combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory and executed by a processor unit. Memory may be implemented within the processor unit or external to the processor unit. As used herein the term “memory” refers to any type of long term, short term, volatile, nonvolatile, or other memory and is not to be limited to any particular type of memory or number of memories, or type of media. Tangible media include one or more physical articles of machine readable media, such as random access memory, magnetic storage, optical storage media, and so on.

If implemented in firmware and/or software, the functions may be stored as one or more instructions or code on a computer-readable medium. Examples include computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer; disk and disc, as used herein, includes compact disc (CD), laser disc, optical disc, digital versatile disc (DVD), and Blu-ray disc where disks usually reproduce data magnetically, while discs reproduce data optically with lasers. Combinations of the above should also be included within the scope of computer-readable media. Such media also provide examples of non-transitory media, which can be machine readable, and wherein computers are an example of a machine that can read from such non-transitory media.

Some or all of the subject matter described herein may be implemented in a computing system that includes a back-end component (e.g., as a data server), or that includes a middleware component (e.g., an application server), or that includes a front-end component (e.g., a client computer having a graphical user interface or a Web browser through which a user may interact with an embodiment of the subject matter described herein), or any combination of such back-end, middleware, or front-end components. The components of the system may be interconnected by any form or medium of digital data communication (e.g., a communication network). Examples of communication networks include a local area network (“LAN”), a wide area network (“WAN”), and the Internet.

The computing system may include clients and servers. A client and server are generally remote from each other and typically interact through a communication network. The relationship of client and server generally arises by virtue of computer programs running on the respective computers and having a client-server relationship to each other.

Unless defined otherwise, all technical and scientific terms used herein have the same meaning as commonly or conventionally understood. As used herein, the articles “a” and “an” refer to one or to more than one (i.e., to at least one) of the grammatical object of the article. By way of example, “an element” means one element or more than one element. “About” and/or “approximately” as used herein when referring to a measurable value such as an amount, a temporal duration, and the like, encompasses variations of ±20% or ±10%, ±5%, or +0.1% from the specified value, as such variations are appropriate in the context of the systems, devices, circuits, methods, and other implementations described herein. “Substantially” as used herein when referring to a measurable value such as an amount, a temporal duration, a physical attribute (such as frequency), and the like, also encompasses variations of ±20% or ±10%, ±5%, or +0.1% from the specified value, as such variations are appropriate in the context of the systems, devices, circuits, methods, and other implementations described herein.

As used herein, including in the claims, “or” as used in a list of items prefaced by “at least one of” or “one or more of” indicates a disjunctive list such that, for example, a list of “at least one of A, B, or C” means A or B or C or AB or AC or BC or ABC (i.e., A and B and C), or combinations with more than one feature (e.g., AA, AAB, ABBC, etc.). Also, as used herein, unless otherwise stated, a statement that a function or operation is “based on” an item or condition means that the function or operation is based on the stated item or condition and may be based on one or more items and/or conditions in addition to the stated item or condition.

As used herein, a mobile device or station (MS) refers to a device such as a cellular or other wireless communication device, a smartphone, tablet, personal communication system (PCS) device, personal navigation device (PND), Personal Information Manager (PIM), Personal Digital Assistant (PDA), laptop or other suitable mobile device which is capable of receiving wireless communication and/or navigation signals, such as navigation positioning signals. The term “mobile station” (or “mobile device” or “wireless device”) is also intended to include devices which communicate with a personal navigation device (PND), such as by short-range wireless, infrared, wireline connection, or other connection—regardless of whether satellite signal reception, assistance data reception, and/or position-related processing occurs at the device or at the PND. Also, “mobile station” is intended to include all devices, including wireless communication devices, computers, laptops, tablet devices, etc., which are capable of communication with a server, such as via the Internet, WiFi, or other network, and to communicate with one or more types of nodes, regardless of whether satellite signal reception, assistance data reception, and/or position-related processing occurs at the device, at a server, or at another device or node associated with the network. Any operable combination of the above are also considered a “mobile station.” A mobile device may also be referred to as a mobile terminal, a terminal, a user equipment (UE), a device, a Secure User Plane Location Enabled Terminal (SET), a target device, a target, or by some other name.

While some of the techniques, processes, and/or implementations presented herein may comply with all or part of one or more standards, such techniques, processes, and/or implementations may not, in some embodiments, comply with part or all of such one or more standards.

The generic principles discussed herein may be applied to other implementations without departing from the spirit or scope of the disclosure or claims.

Although particular embodiments have been disclosed herein in detail, this has been done by way of example for purposes of illustration only, and is not intended to be limiting with respect to the scope of the appended claims, which follow. In particular, it is contemplated that various substitutions, alterations, and modifications may be made without departing from the spirit and scope of the invention as defined by the claims. Other aspects, advantages, and modifications are considered to be within the scope of the following claims. The claims presented are representative of the embodiments and features disclosed herein. Other unclaimed embodiments and features are also contemplated. Accordingly, other embodiments are within the scope of the following claims.

What is claimed is:

1. A method comprising:
determining whether a current validation value, representative of an expected value resulting from application of a validation function to current certificate data used by a computing device, is to be replaced, wherein the current validation value is stored in a write-restricted non-volatile memory unit of the computing device;
determining at boot time whether a physical presence indicator, configured to be non-actuatable from non-proximate locations, is set to a value indicating that an actuation mechanism, configured to cause actuation of the physical presence indicator in order to cause content change for the write-restricted non-volatile memory unit, has established physical presence with the computing device; and
providing a new validation value, representative of a new expected value resulting from application of the validation function to new certificate data used by the computing device, in response to determining that the current validation value is to be replaced and that the physical presence indicator is set to the value indicating that the actuation mechanism has established the physical presence with the computing device.

2. The method of claim 1, wherein the actuation mechanism includes one of a jumper or a dip switch.

3. The method of claim 1, wherein the actuation mechanism comprises a baseboard management controller (BMC) of the computing device, the BMC configured to, at least in part, actuate the physical presence indicator.

4. The method of claim 1, wherein the current certificate data comprises a current root certificate of a current certificate chain configured to perform signature verification.

5. The method of claim 4, wherein the current validation value comprises an expected hash value derived by application of a hash function to the current root certificate.

6. The method of claim 1, wherein providing the new validation value comprises:
disabling the current validation value by setting a current status identifier associated with the current validation value to a current status value indicating that the current validation value is revoked; and
activating the new validation value.

7. The method of claim 6, wherein activating the new validation value comprises one of:
activating one of multiple pre-stored validation values provided on the write-restricted non-volatile memory unit of the computing device, or
storing on the write-restricted non-volatile memory unit of the computing device the new validation value provided from a location external to the write-restricted non-volatile memory unit.

8. The method of claim 1, wherein determining whether the current validation value is to be replaced comprises:
determining during a device reset operation whether the computing device contains a new root-of-trust content; and
setting, in response to determining that the computing device contains the new root-of-trust content, a hardware indicator to a value allowing modification of the write-restricted non-volatile memory unit storing the current validation value.

9. The method of claim 8, wherein determining whether the computing device contains the new root-of-trust content comprises determining by a primary boot loader (PBL) whether a secondary boot loader (SBL) contains the new root-of-trust content;
and wherein setting the hardware indicator to the value allowing modification of the write-restricted non-volatile memory unit comprises setting, in response to determining that the SBL contains the new root-of-trust content, the hardware indicator to the value allowing modification of the write-restricted non-volatile memory unit storing the current validation value.

10. The method of claim 9, further comprising:
installing on one or more memory units of the computing device, in response to a determination that the hardware indicator is set to the value allowing modification of the write-restricted non-volatile memory unit, data corresponding to the new root-of-trust content;
upon installation of the data corresponding to the new root-of-trust content, deleting the new root-of-trust content from the SBL; and
causing a reboot of the computing device.

11. The method of claim 1, wherein the computing device comprises one of: a mobile computing device or a stationary computing device.

12. The method of claim 1, wherein the write-restricted non-volatile memory unit of the computing device storing the current validation value comprises write-restricted memory implemented, at least in part, as one-time programmable read-only-memory (ROM).

13. A computing device comprising:
at least one write-restricted non-volatile memory unit;
a physical presence indicator; and
one or more processors, coupled to the at least one write-restricted non-volatile memory unit and the physical presence indicator, the one or more processors configured to:
determine whether a current validation value, representative of an expected value resulting from application of a validation function to current certificate data used by the computing device, is to be replaced, wherein the current validation value is stored in the at least one write-restricted non-volatile memory unit of the computing device;
determine at boot time whether the physical presence indicator, configured to be non-actuatable from non-proximate locations, is set to a value indicating that an actuation mechanism, configured to cause actuation of the physical presence indicator in order to cause content change for the at least one write-restricted non-volatile memory unit, has established physical presence with the computing device; and
provide a new validation value, representative of a new expected value resulting from application of the validation function to new certificate data used by the computing device, in response to determining that the current validation value is to be replaced and that the physical presence indicator is set to the value indicating that the actuation mechanism has established the physical presence with the computing device.

14. The computing device of claim 13, further comprising:
the actuation mechanism, wherein the actuation mechanism includes one of:
a mechanical actuator comprising one of: a jumper, or a dip switch; or
a baseboard management controller (BMC) in electrical communication with the physical presence indicator, the BMC configured, in part, to actuate the physical presence indicator in response to authorization from a party authorized to access the BMC;
wherein when the physical presence indicator is actuated to an ON state, the new validation value is allowed to be provided to the at least one write-restricted non-volatile memory unit of the computing device.

15. The computing device of claim 13, wherein the at least one write-restricted non-volatile memory unit storing the current validation value comprises write-restricted memory implemented, at least in part, as one-time programmable read-only-memory (ROM).

16. The computing device of claim 13, wherein the one or more processors configured to provide the new validation value are configured to:
disable the current validation value by setting a current status identifier associated with the current validation value to a current status value indicating that the current validation value is revoked; and
activate the new validation value.

17. The computing device of claim 16, wherein the one or more processors configured to activate the new validation value are configured to perform one of:
activate one of multiple pre-stored validation values provided on the at least one write-restricted non-volatile memory unit of the computing device, or
store on the at least one write-restricted non-volatile memory unit of the computing device the new validation value provided from a location external to the at least one write-restricted non-volatile memory unit.

18. The computing device of claim 13, wherein the one or more processors configured to determine whether the current validation value is to be replaced are configured to:
determine during a device reset operation whether the computing device contains a new root-of-trust content; and
set, in response to determining that the computing device contains the new root-of-trust content, a hardware indicator to a value allowing modification of the at least one write-restricted non-volatile memory unit storing the current validation value.

19. The computing device of claim 18, wherein the one or more processors configured to determine whether the computing device contains the new root-of-trust content are configured to determine, by a primary boot loader (PBL), whether a secondary boot loader (SBL) contains the new root-of-trust content;
and wherein the one or more processors configured to set the hardware indicator to the value allowing modification of the at least one write-restricted non-volatile memory unit are configured to set, in response to determining that the SBL contains the new root-of-trust content, the hardware indicator to the value allowing modification of the at least one write-restricted non-volatile memory unit storing the current validation value.

20. A non-transitory computer readable media programmed with instructions, executable on a processor, to:
determine whether a current validation value, representative of an expected value resulting from application of a validation function to current certificate data used by a computing device, is to be replaced, wherein the current validation value is stored in a write-restricted non-volatile memory unit of the computing device;
determine at boot time whether a physical presence indicator, configured to be non-actuatable from non-proximate locations, is set to a value indicating that an actuation mechanism, configured to cause actuation of the physical presence indicator in order to cause content change for the write-restricted non-volatile memory unit, has established physical presence with the computing device; and
provide a new validation value, representative of a new expected value resulting from application of the validation function to new certificate data used by the computing device, in response to determining that the current validation value is to be replaced and that the physical presence indicator is set to the value indicating that the actuation mechanism has established the physical presence with the computing device.
